(19) United States
(12) Patent Application Publication
(10) Pub. No.: US 2024/0082789 A1
(43) Pub. Date: Mar. 14, 2024

(54) Filtration Device

(71) Applicant: Sani Membranes ApS, Farum (DK)

(72) Inventor: Henrik Hjelmsmark, Farum (DK)

(21) Appl. No.: 18/262,006

(22) PCT Filed: Jan. 18, 2022
(86) PCT No.: PCT/EP2022/050957

§ 371 Date: Jul. 18, 2023

(30) Foreign Application Priority Data
Jan. 20, 2021 (DK) PA 2021 00059

(51) Int. Cl. B01D 63/16; B01D 63/08

(52) U.S. Cl. CPC B01D 63/16; B01D 63/08; B01D 2315/04; B01D 2321/2058

(57) ABSTRACT

The present invention relates to a filtration device being adapted for continuous vibration and pressure driven filtration. Said filtration device comprises a filter module which comprises at least one flat vessel chamber, said vessel chamber further comprises a semipermeable membrane covering a drain area, an inlet for feed fluid, an outlet for permeate and an outlet for retentate; said vessel chamber further comprises one or more flexible volume chambers being filled with gas and in close contact with but separated from the internal vessel chamber of the filter module through a flexible wall; said filtration device comprises a vibration motor being adapted to provide a vibrating motion to the device.

### FIELD OF THE INVENTION

The present invention relates to a filtration device being adapted for continuous vibration and pressure driven filtration. Said filtration device comprises a filter module which comprises at least one flat vessel chamber, and said vessel chamber further comprises a semipermeable membrane covering a drain area, an inlet for feed fluid, an outlet for permeate and an outlet for retentate; said vessel chamber further comprises one or more flexible volume chambers being filled with gas and in close contact with but separated from the internal vessel chamber of the filter module through a flexible wall; said filtration device comprises a vibration motor being adapted to provide a vibrating motion to the device. As the gas in the in the flexible volume chambers can expand and compress the invention allows for the retentate in the vessel chamber to move relative to the membrane as the filter module is vibrated. The inertia of the retentate will counter the move of the module creating a washing of the membrane surface by the retentate and this will keep the membrane clean and so secure continuous fouling free filtration using a minimal of energy.

The filtration device of the invention is useful for operations, such as fine filtration, microfiltration and ultrafiltration of liquids using a semipermeable membrane, where the membrane is typically subjected to a tangential flow of feed fluid. The filtration device is useful in operations where a robust and sanitary, fouling preventing continuous filtration is desirable, and the filtration device is capable of being configured to filtering operations of a wide range of fluid volumes, such as volumes as small as about 100 mL and being scalable to filter larger volumes, such as 100 m³.

### DESCRIPTION OF THE PRIOR ART

Published international patent application No. WO2018145714A1 discloses a vibrating device adapted for vibration of a filter plate assembly adapted for continuous vibration driven filtration, where said vibration device comprises a vessel housing having a vessel pressure chamber, and where said filter plate assembly, which may comprise additional semipermeable membranes, and which comprises a plurality of filter plates comprising one or more permeate channels and one or more permeate outlet or exits extending perpendicular to the filter plate assembly through said vessel housing, and where said filter plate assembly is rigidly mounted inside said vessel pressure chamber, said vibrating device comprising at least one retentate inlet adapted for a retentate stream to enter the vessel housing, and at least one retentate outlet from the vessel housing, said vibrating device further comprising a vibration motor which provides a vibrating motion to the vessel housing, where said vibrating device comprises one or more flexible volume chambers being filled with gas and being adapted to expand and/or compress the volumes of the chambers inside the vessel housing to allow the retentate in the vessel chamber to move in parallel relative to the surface of said filter plates, when said vessel housing is subjected to a vibrating motion. This vibrating filtration device is capable of filtration, such as microfiltration or ultrafiltration, of fluids at reduced energy expenditure. The use of filter plates, however, puts a limit on the down-scaling size obtainable as well as to the design (of chamber) to secure functionality of the flexible volume (cushion) chambers.

### SUMMARY OF THE INVENTION

It is an object of the present invention to provide a filtration device having a simplified vessel housing construction with optimized free flow filtering capacity and being capable of maintaining a high flux in a continuous pressure and vibration driven filtration process while having a wide range of scaling sizes for filtration of very small volumes of fluids as well as large volumes using the same general construction configuration.

This is achieved by the filtration device of the invention comprising an internal flat vessel chamber being in contact with typically two flexible volume chambers filled with gas and the flexible volume chambers having a flexible chamber wall (14) planar to the vessel chamber (5), and being adapted to expand and/or compress their volumes thus allowing the feed fluid or retentate in the internal vessel chamber to move in parallel (tangentially, back and forth) relative to the surface of a semipermeable membrane covering a drain area when said filtration device comprising said semipermeable membrane is subjected to a vibrating motion, said movement of retentate relative to the housing caused by the inertia of the media and made possible through the flexible volume chambers in either end of the movement.

The invention provides a freely movable filtration device (1) comprising a filter module (2), being adapted for continuous vibration driven filtration of fluids, where said filter module (2) comprises at least two fitting and typically non-identical half parts (3) and (4) being adapted for edgewise bonding thus creating an internal flat vessel chamber (5), where part (3) comprises in one end a feed inlet (6) and in the opposite end a retentate outlet (7), and where said part (3) further comprises at least one flexible volume chamber (8a, 8b) being filled with gas and being spaced apart such as being positioned (distally) in each end of part (3) and so of vessel chamber (5) and proximal to the feed inlet (6) and the retentate outlet (7), respectively, and where part (4) comprises a permeate outlet (9) in contact with a drain area (10); said filter module (2) further comprising a semipermeable membrane (11) covering said drain area (10) and separate fluid in the drain area (10) from liquid in the vessel chamber (5); and said filtration device further comprising means for providing vibrating motion eg. a vibration motor (12) having a receptacle (13) for mounting said filter module (2), said vibration motor (12) being adapted to provide a vibrating motion to the filter module (2), characterized in that said flat vessel chamber is created by 2 adjoining parts and said flexible volume chamber (8a, 8b) with flexible chamber wall (14) are planar to the flat vessel chamber and are adapted to expand and/or compress their gas volumes thus allowing the retentate or fluid to be filtered in the vessel chamber (5) to move in parallel (back and forth) relative to the surface of said semipermeable membrane (11), when said filtration device (1) is subjected to a vibrating motion.

Hereby a simple construction is obtained using a limited number of components allowing the same construction configuration for a wide range of device sizes corresponding to feeds of very small volumes as well as much larger volume. A considerable advantage is that filtration data obtained for small test volumes using the filtration device of the invention can easily be extrapolated to much larger industrial type volumes using an up-scaled version of the filtration device.

Using the device of the invention the liquid media to be filtered is vibrated relative to the surface of the semipermeable membrane and as pressure in the vessel chamber (5) is kept higher than the pressure in the drain areas (10) permeate is passed onto the drain area so that free flow filtration is obtained and the medium to be filtered can even be highly viscous and may contain larger particulate impurities, as long as the medium do not block the free flow passage through the device.

An optimized cleaning functionality of the membrane is achieved using the vibrating filtration device of the invention by applying movement of the medium relative to the filter module and thus the membrane surface through which the media is to be filtered, and this relative movement is achieved when the filter module is vibrated, and the fluid medium has room or is allowed not to move with the plate due to the inertia of the medium. The vibration can hereby keep the membrane surface free and clean, maintaining high flux through the membrane in a continuous filtration process. The media to be filtered, the retentate, can be concentrated in the device or continuously pass from inlet to outlet while being concentrated.

In an embodiment, the vibrating movement of the filter module is achieved through oscillating air feed to the air volume cushions, whereby the air cushions also work as vibrating motor as the inertia of the media moves the filter module 2 as if the motion was driven by an external drive (12).

In an embodiment, the feed is entered in one corner of a rectangular filter-plate assembly and concentrate is exited in the opposite corner. An additional de-aeration exit in the upper sider can be used for de-aeration of the vessel.

If a uniform retentate is wanted throughout the vessel chamber, this can be achieved by circulating concentrate from the exit back to the vessel entry side while adding unconcentrated media to the circulation, or the media can circulate over a tank while being concentrated as permeate is drained from the circulation through the membrane and drain area.

In an embodiment each of the two flexible volume chambers (8a, 8b) comprise a flexible gasket (14) being adapted to separate the gas volume of the flexible volume chambers (8a, 8b) from the vessel chamber (5), and the remaining walls (15) of the flexible volume chambers being rigid. An alternative flexible volume chamber can be formed as a fully flexible vessel shaped cushion chamber or a tubular formed cushion chamber sealed off from the vessel chamber (5).

In an embodiment one or more flexible volume chambers (8a, 8b) comprising flexible gas enclosures are positioned in the periphery or rim of the vessel chamber (5) whereby a circular like movement of the vessel chamber can be utilized instead of a linear movement of the device.

In an embodiment the drain area (10), permeate outlet (9), the covering edge sealed membrane (11), the flexible volume chambers (8a, 8b), the vessel chamber (5), the feed inlet (6) and the concentrate outlet (7) are all positioned in half part (3) whereby half part (4) can be a flat planar plate, or be identical to part (3), or be with drain area (10) covered with edge sealed membrane (11) with permeate exit (9) positioned suitable drainage of permeate from the device. Hence the device can be built up by several layers with internal vessel chambers for continuous vibration and pressure driven filtration obtained through flexible gas cushions and media inertia.

In an embodiment said vibration motor (12) is adapted to provide vibrating motion of a linear or circular nature or a combination of both. The vibration motor can as example be electrical with a circulating unbalance weight or pneumatic with back-and-forth moving counterweight creating an active or reactive movement of the filtration module (2) when the module is flexibly supported allowing for said movement.

In an embodiment said vibration motor (12) provides vibration to said filter module (2) through an eccentric axis (19) whereby the filtration module is directly actuated by the drive motor. This design will provide a very simple mechanical solution of the device.

In an embodiment the filtration device of the invention comprises two or more filter modules (2) being connected through an eccentric axis (19) and structurally adapted to balance out vibrations and to avoid external vibration.

In an embodiment, the filter feed pressure and air cushion pressure are adjusted to be the same, maximizing the efficiency of the air cushions. In all designs caution must be taken to avoid a higher feed pressure than allowed in vessel design. Also the air cushions must be sized or pressurized to secure that they operate optimally as air springs for the moving liquid in the vessel chamber.

In an embodiment, the device is cleaned by substituting feed with rinse water or cleaning media and increasing flow over the membrane by circulating the media at high flow rate from inlet to outlet while maintain the rinsing function through vibration.

In an embodiment, the feed is provided by a tank with air or (inert) gas under pressure, and the pressurized gas act as feed pump, pressing the feed into the filtration device. This feed system can provide a stable feed at very low cost and using only simple off the shelf elements. The pressurized gas can be connected to the air cushions 8a, 8b optimizing the function of the gas cushions.

In an embodiment, the feed is provided by a tank wherein a sterile bag contains the feed media, with air or gas under pressure, and the pressurized gas act as feed pump, pressing the feed into the filtration device. This feed system can provide a stable, sterile feed at very low cost and using only simple off the shelf elements.

In an embodiment, the vibrating vessel chamber is formed in see-through materials or with see-through inspection glasses whereby the semipermeable membrane, the drain area and media can be visually inspected during filtration process and cleaning.

Materials used for the filtration device can be selected from polymeric or co-polymeric thermoplastics or any other suitable material that can withstand the media to be filtered, the applied pressure, such as up to about 5 bar or higher, the temperature span needed, such as from about 5° C. to about 95° C. as well as the medias used for cleaning the filter module. All parts of the device may be produced as one or more parts by 3D printing. The choice of material must foresee thermal expansion and rigidity of the module and be sustainable to pressure and vibration. Preferred execution is a vessel in stainless steel, polycarbonate or polypropylene, and the filtration membrane is preferably a semipermeable membrane, such as an asymmetric polymeric membrane. All materials are readily accessible in food grade versions on the market.

### Definitions

The term “permeate” is used for the media that has passed through the filter.

The term “retentate” relates to the media to be filtered.

The term “concentrate” as used herein shall mean retentate that has been concentrated through the filtration process.

The term “feed” or “media” or “medium” is used herein interchangeably for the media stream to be filtered said media stream is typically a liquid but can be in form of a gas with a mass sufficient to have an inertia resisting vibrational move.

The term “flexible volume chambers”, air cushion and gas cushion are all used interchangeably.

The term “fine filtration” applies to filtration through slits or holes in the filter-plates of 5 to 50 microns, whereas the term “microfiltration” usually applies to particle sizes between a few hundredths of micrometers and tens of micrometers and is carried out at low differential pressure from just above zero to a few bars. Microfiltration is for example used for sterile filtration of milk. The term “ultrafiltration” is for example used for separating large organic molecules from mineral molecules or small organic molecules and in the ultrafiltration process a higher differential pressure of 1-15 bars may be needed.

When membranes, such as semipermeable membranes are used in a crossflow configuration, the media to be filtered is pumped at a speed of 2 to 5 meter per second across the surface of the membrane to keep solids from building up and depositing on the membrane and to keep a boundary layer above the membrane surface as small as possible, hereby keeping the membrane free and functional for a longer time in operation. The same effect is achieved by moving the membrane relative to the media as achieved in present invention.

### DETAILED DESCRIPTION OF THE INVENTION

An embodiment of the invention relates to the vibrating device (1) wherein the filter module (2) comprises two or more flexible gaskets (14), said flexible gaskets being adapted to separate the volume of the vessel pressure chamber (5) and the volume of the flexible volume chambers (8A, 8B). Advantages of using flexible gaskets are that the cushion effect can be achieved in a hygienic design.

An embodiment of the invention relates to the vibrating device (1) wherein is only one flexible volume chamber (8A, 8B) positioned in the entire circumference of the filter area (11) where part of the flexible volume chamber is exposed to higher pressure from the media than the distally opposite part of the membrane area, said pressure induced by the filter device (1) being vibrated and the media in chamber (5) through inertia try to stay in position.

An embodiment of the invention relates to the vibrating device (1) wherein the one or more flexible volume chambers (8A, 8B) are formed as gas filled balloons positioned in the vessel chamber or in a cavity as example as the areas indicated by (8A, 8B). Advantages of using the gas filled balloons are that these can be easily sealed to form a gas cushion and pressure can act on the cushion from all sides.

An embodiment of the invention relates to the vibrating device (1) as described above, wherein the vessel chamber (5) comprises one or more pressure valves adapted to control the pressure in the flexible volume chambers (8A, 8B) so that the pressure is balanced with the retentate or media to be filtered in the vessel. Advantages are that when the volume of the flexible volume chamber is large the spring effect of the cushion is increased thus allowing the media to move easily relative to the planar membrane.

A further embodiment of the invention relates to the vibrating device (1) as described above, wherein the vibrating device (1) comprises two or more filter modules (2), said two or more filter modules (2) are connected and structurally adapted to balance out vibrations and to avoid external vibration.

A further embodiment of the invention relates to the vibrating device (1) as described above, wherein the filter module (2) comprises a back mix connections, said back mix connections being adapted such that the retentate to be filtered can be homogenized through circulation through one or more back mix connections for moving retentate from one area of the vessel chamber (5) to another area of the vessel chamber (5).

A further embodiment of the invention relates to the vibrating device (1) as described above, wherein the vibrating device (1) comprises at least one flexible support, where the device (1) is supported by said at least one flexible support allowing vibrating movement of the device (1), where said at least one flexible suspension can be guiding the vibration movement. The advantage of flexible suspension is that the vibration can executed without external reactions or vibrations of the supporting foundation.

A further embodiment of the invention relates to the vibrating device (1) as described above, wherein said vibration motor (12) is adapted to provide vibrating motion of a linear or circular nature or a combination of both. Either form of movement has advantages for providing simple suspension and for simple vibration drive motor for the movement.

A further embodiment of the invention relates to the vibrating device (1) as described above, wherein the flexible volume chambers (8A, 8B) in the filter module (2) are connected via the pressure valves to a gas pressurized feed tank adapted for media or retentate to be filtered, said gas pressure pushing the feed to the vessel chamber (5) said gas pressure balancing retentate pressure in the flexible volume chambers (8A, 8B) and in the vessel chamber (5). An advantage of this embodiment is the provision of a simple means of equalizing gas pressure in the flexible volume chambers to that of the fluid pressure in the vessel chamber.

In an embodiment, the filter membrane is edgewise bonded to the vessel chamber or pressed in between to vessel chamber parts and where the membrane is further bonded in points to the supporting drain area (10) said bonding points keeping the membrane fixed to the drain area and so the filter module during vibration of the device.

In an embodiment, the flat vessel chamber (5) is formed by a flat cavity in either part or both parts of the two juxtaposed module half parts, said cavity height and form defining the flow area above the membrane between two juxtaposed planar walls of the vessel chamber where off at least one wall is covered by semi permeable membrane, drain area and outlet, and the filter-plate assembly (2) forms a rigid singular assembly through edgewise bonding. Said cavity forming the vessel chamber can be formed to allow for free flow of media from the at least one inlet (6) to all areas of the membrane (11) and further to the at least one retentate outlet (7) securing an optimal distribution of media to the filtering membrane surface.

In and embodiment of the filtration device (1), the vessel chamber (5) has an overall planar design with at least one planar side is covered by semipermeable membrane (11) where the planar side of the vessel chamber is formed with an overlaying structure that increase turbulence of the media when vibrated relative to the membrane.

In an embodiment, the filter module (2) comprises actuation means (12) for mechanical actuation of the filter-plate assembly in a plane parallel to the extent of the filter membrane (11).

The flexible volume chambers can be formed as individual balloons in the retentate vessel chamber (5). However, for improved hygiene and as shown in FIG. 1 the gas filled flexible volume chambers (8A, 8B) are in certain embodiments formed as sealed off parts of the vessel, where a flexible gasket (14) separates the cushion gas volume from the retentate volume. The cushion chambers are optimally placed on opposite sides or ends of the filter area (11) and in the direction of motion, when the vessel housing is vibrated to allow for optimal movement of retentate in relation to the planar surface of membrane in the filter module.

In an embodiment, the filter module assembly (2) comprises a plurality of filter-membranes (11) where the filter areas are situated parallel juxtaposed forming the flat vessel housing and having the membrane surface facing the membrane surface of an adjacent half part.

In an embodiment the filter module assembly comprises a plurality of plastic molded planar square or rectangular filter half plates (3, 4) and a plurality of permeate outlets or exits (9), media entries (6) and retentate outlets or exits (7) where by a larger vibrating membrane assembly can be established.

The filter device, such as is illustrated in FIG. 3, comprises a plurality of planar, filter membrane areas and one or more edge positioned permeate outlets or exits. The filter module (2) is vibrated in the same plane as the plates with a vibration motor with amplitude of typically 2-25 mm at frequency between 5 and 50 Hz. The vessel includes two or more air cushions formed as flexible volume chambers or balloons positioned in each side of the vibrating direction and on each side of the filter-plate assembly, allowing the media to be filtered to move relatively to the filter surfaces as the filter module is with the vibrating motor (12) and the air cushions are squeezed or expanded to allow for the relative movement of the retentate.

The vibrating motor is typically a motor driven eccentric weight or an eccentric piston connection or pneumatic piston but other means are also available. The vessel has to be of a robust design that can sustain the vibration as well as the required internal pressure, as the internal pressure corresponds to the trans membrane pressure, given that permeate can flow unrestricted from the permeate exit(s).

The device is typically mounted on or hanging from springs or elastic mounts allowing for the vibrating movement. The module design is typically adjusted to tightly enclose the filter membrane and assembly to avoid larger dead volumes in the vessel.

The vibrating filter device (1) can be used for vibration driven dead-end filtration operation, where the media is concentrated in the vessel chamber (5) and discharged at the end of operations or intermittently.

The vibrating filter device (1) can be used for continuous or intermittently vibration driven filtration operation, where one phase of the media is concentrated in the vessel chamber (5) and the vibration action keeps the flux of the filter area from leveling off.

The vibrating filter device (1) can be used for continuous separating gas or liquids entering the device through inlet (6) said liquid with high solids content (such as up to up to 1% wt, such as up to 5% wt, such as up to 10% wt, such as up to 15% wt, such as up to 20% wt, such as up to 25% wt, such as up to 30% wt, such as up to 40% wt, such as up to 50% wt) or with high viscosity (such as up to up to 10 cP, such as up to 50 cP, such as up to 100 cP, such as up to 500 cP, such as up to 1000 cP, such as up to 2000 cP, such as up to 5000 cP, such as up to 10000 cP, such as more than 10000 cP), or with high sanitary demand (such as cell count up to 10¹ cfu/mL, such as up to 10² cfu/mL, such as up to 10³ cfu/mL, such as up to 10⁴ cfu/mL, such as up to 10⁵ cfu/mL, such as up to 10⁶ cfu/mL, such as up to 10⁷ cfu/mL, such as up to 10⁸ cfu/mL, such as more than 10⁸ cfu/mL), or for concentrating or separating such as polypeptides, enzymes, proteins, yeast, or cells in a liquid and/or a combination thereof in a permeate phase exiting the device through exit (9) and a retentate phase exiting the device through exit (7).

### DESCRIPTION OF THE FIGURES

FIG. 1 is a cross-sectional view of an embodiment of the filtration device having one filter module with one vessel chamber. In the illustrated embodiment, the media or retentate entry (6) and retentate exit connection (7) as well as gas cushion chamber (8A) and (8B) are placed in either end of the cavity forming the long flat vessel chamber (5) in the half part (3). The membrane (11) is forming the opposite vessel chamber wall positioned on top of the drain area (10) said drain area is positioned in a cavity in half part (4) where the permeate drain (9) is shown. The cushion chambers (8A, 8B) are sealed off from the vessel chamber (5) by a very flexible gasket membrane (14) that is parallel to the flat vessel chamber and is edge wise sealed to the half part (3). The membrane (11) is edge wise sealed and bonded to half part (4) or sealed when squeezed in between part (3) and part (4) as these are edge wise bonded together and forming the filter module (2). The filter module is connected to the driving motor (12) through the connection device or receptacle (13) and the device can vibrate back and forth or up and down when suspended in suitable springs. Connections for media, permeate and retentate must be very flexible to allow for the vibrational movement of the device.

FIG. 1A is an inside view of part (3) the embodiment of a filter module shown in FIG. 1. In the illustrated embodiment, the media or retentate entry (6) and retentate exit connection (7) as well as gas cushion chamber (8A) and (8B) are placed in either end of the cavity forming the long flat vessel chamber (5) in the half part (3). The cushion chambers (8A, 8B) are sealed off from the vessel chamber (5) by a very flexible gasket membrane that is parallel to the flat vessel chamber and is edge wise sealed to the half part (3).

FIG. 1B is an inside view of part (4) of the embodiment of a filter module shown in FIG. 1. In the illustrated embodiment, the membrane (11) (shown in part) is forming the opposite vessel chamber wall positioned on top of the drain area (10) (shown in part) said drain area is positioned in a cavity in half part (4) where the permeate drain (9) is shown. The membrane (11) is edge wise sealed and bonded to half part (4) or sealed when squeezed in between part (3) and part (4) as these are edge wise bonded together and forming the filter module (2).

FIG. 2 illustrates one embodiment of a cross-sectional view of a vibrating device (1) having one filter module with one vessel chamber. In the illustrated embodiment, the media or retentate entry (6) and retentate exit connection (7) as well as membrane (11) and drain area are positioned in half part (15). The membrane (11) is forming the one side vessel chamber wall and is positioned on top of the drain area (10) said drain area is positioned in a cavity in half part (15) where the permeate drain (9) is shown. The membrane (11) is edge wise sealed and bonded to half part (20). Gas cushion chamber (8A) and (8B) are placed in either end of the long flat vessel chamber (5) in the half part (16). The cushion chambers (8A, 8B) are sealed off from the vessel chamber (5) by a very flexible gasket membrane (14) that is parallel to the flat vessel chamber and is edge wise sealed to the half part (16). The two half parts (20) and part (16) are edge wise bonded together and forming the filter module (2). The filter module is connected to the driving motor (12) through the connection device or receptacle (13) and the device can vibrate back and forth or up and down when suspended in suitable springs. Connections for media, permeate and retentate must be very flexible to allow for the vibrational movement of the device.

FIG. 3 illustrates one embodiment of a cross-sectional view of a vibrating device (1) with one filter module comprising 2 flat vessel chambers each with 2 membrane areas build up as a sandwich construction of 3 parts (17a, 18, 17b). In the illustrated embodiment, a media or retentate entry (6) and retentate exit connection (7) and internal channel connects the 2 vessel chambers, the flexible cushions as well as a membrane (11) and drain area and permeate drain (9) are positioned in part (17). Further a module part (18) with membrane covered drain are on both sides and permeate exit on the edge is positioned in between 2 outer parts (17a, 17b). The three module parts (17a, 18 and 17b) are edge wise bonded together and forming the filter module (2). The filter module is connected to the driving motor (12) through the connection device or receptacle (13) and the device can vibrate back and forth or up and down when suspended in suitable springs. As can be seen, many units can be built together thereby forming a large unit. Connections for media, permeate and retentate must be very flexible to allow for the vibrational movement of the device.

FIG. 4 illustrates one embodiment of a vibrating filtration device (1) with filter module (2) connected through a receptacle (13) and a piston arm to a vibration drive motor (12) with eccentric axle (19).

FIG. 5 illustrates one embodiment of a vibrating filtration device (1) with 2 filter modules (2) connected through receptacle (13) and piston arms to a vibration drive motor (12) with eccentric axles (19). As the two filter modules moves in opposite directions, external vibrations can be eliminated.

FIG. 6 illustrates one embodiment of a vibrating filtration device (1) with one filter module (2) connected to a feed tank, where feed is pumped from the feed tank (by gas being pumped into the feed tank, and the pressured gas forces the feed into the vessel chamber (5) via the feed or retentate entry (6). The same gas that pumps the feed is connected to the cushion chambers (8A, 8B) where by the pressure is the same in the retentate chamber (5) and the cushion chambers, allowing for a improved movement of the retentate in relation to the chamber during the vibration movement of the filter module (2) as the air cushions (14, 15) are squeezed or expanded.

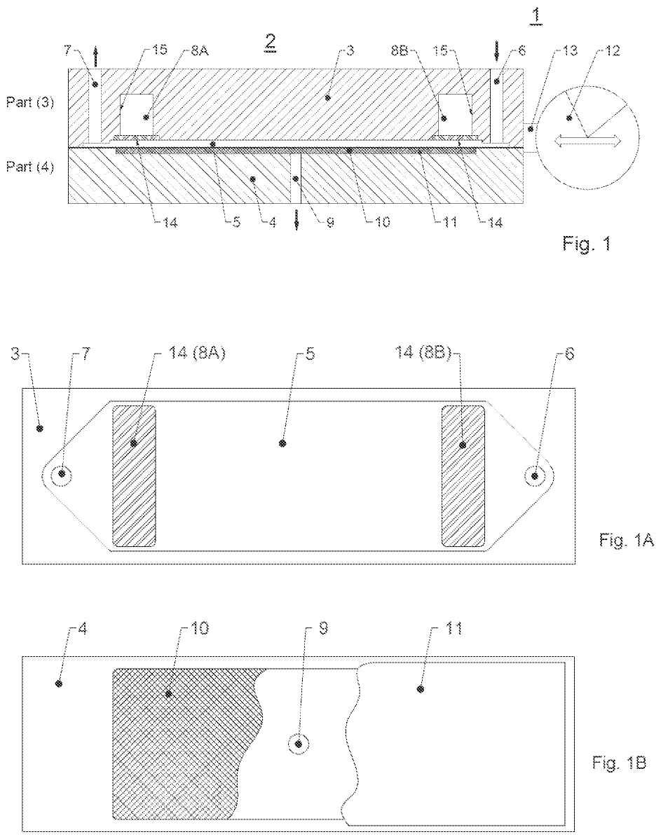

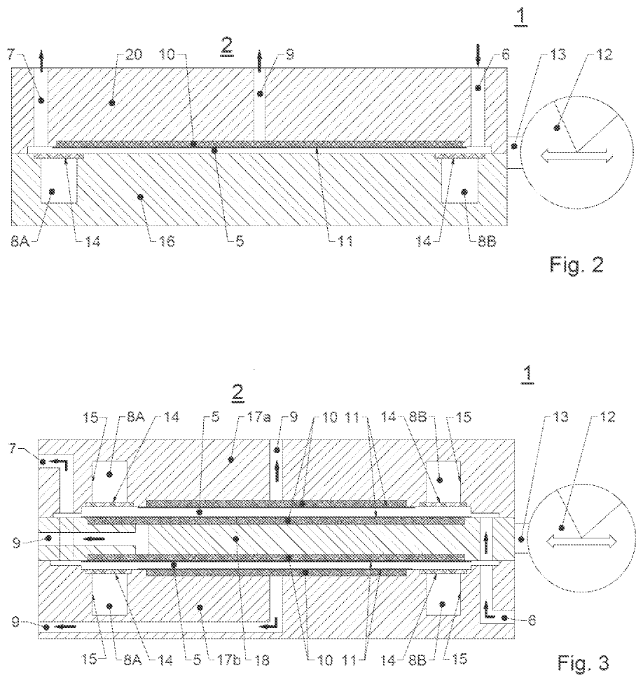

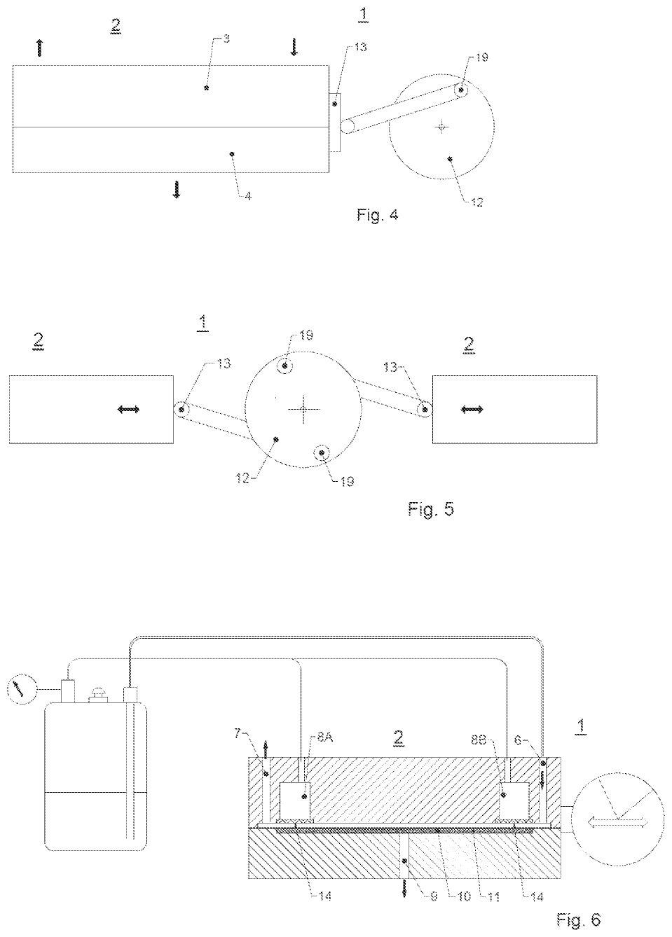

In a not shown embodiment, the feed is pumped into the device by a suitable feed pump and gas in the flexible volume chambers (14,15) can be adjusted by other means. In a not shown embodiment, a feed mixing pump is connected to the retentate exit (7) and to a feed or retentate back mix inlet connection (6), and this mixing pump can be used during operation to homogenize the retentate, or to ensure mixing during cleaning of the device.

It goes without saying that different modifications may be made to the examples described, without departing from the scope and spirit of the invention.

The design shown allows for production of very small filter units for continuous filtration with very little dead volume inside as is a requested feature in drug development. It shall however be noted that the overall design hereby provides up-scaling possibilities to have many square meters of filtration area in one compact Filtration Unit.

All parts can be of food and pharmaceutical grade material with traceable origins, making the Filtration Unit suitable for human food consumables and the likes. The materials used are preferably of a plastic material that can be reused by re-melting or burned as a clean fossil-like fuel. The parts of the unit can be produced by 3 D printing or sintering or by other means.

### Working Examples

A new 35 cm2 filter assembly with a 500 kDa fluoropolymer membrane was mounted in the vessel chamber of the filter module and the filter module was mounted in the vibration drive unit. The Vibro unit was checked for leaks with water at 2 bar.

A 30 min. lye wash pH 11 with 1.25% Divos 120 CL at 50° C. was performed at 0.5 bar pressure and the vibration motor at 15 Hz with partly opened retentate outlets. The unit was drained and flushed thoroughly with water. The unit was drained, and water was used as the media in a dead-end filtration at 1.0 bar with the vibration motor at 15 Hz and closed retentate outlets. The average flux was measured after 10 min. to 400 LMH over a 5 min period.

The unit was drained, and orange juice was used as the medium in a dead-end filtration at 1.5 bar with the vibration motor at 15 Hz and closed retentate outlet. The time was registered at each 5 ml of permeate produced and the average flux between the measuring points was calculated. The results are listed in Table 1.

TABLE 1

| Time (sec) | Permeate Volumen (ml) | Permeate Flux* (LMH) |
|---|---|---|
| 0 | 0 | — |
| 40 | 5 | 125 |
| 80 | 10 | 101 |
| 140 | 15 | 97 |
| 200 | 20 | 87 |
| 270 | 25 | 80 |
| 340 | 30 | 76 |
| 420 | 35 | 67 |
| 500 | 40 | 57 |
| 600 | 45 | 56 |
| 700 | 50 | 55 |
| 800 | 55 | 54 |
| 900 | 60 | 53 |
| 1000 | 65 | 47 |
| 1160 | 70 | 42 |
| 1260 | 75 | 42 |
| 1390 | 80 | 41 |
| 1500 | 85 | 39 |

*Average Flux between the last and the current measuring point

The unit was drained, and water was used as the media in a continuous filtration at 1.0 bar with the vibration motor at 15 Hz and partly opened retentate outlet for 15 min.

A 30 min. lye wash pH 11 with 1.25% Divos 120 CL at 50° C. was performed at 0.5 bar pressure and the vibration motor at 15 Hz was performed with partly opened retentate outlets. The unit was drained and flushed thoroughly with water.

The unit was drained, and water was used as the media in a dead-end filtration at 1.0 bar with the vibration motor at 15 Hz and closed retentate outlets. The average flux was measured after 10 min. to 390 LMH over a 1 min period.

The unit was drained, and orange juice was used as the media in a dead-end filtration at 1.5 bar with the vibration motor stopped and closed retentate outlet. The time was registered at each 5 ml of permeate produced and the average flux between the measuring points was calculated. The results are listed in Table 2.

TABLE 2

| Time (sec) | Permeate Volumen (ml) | Permeate Flux* (LMH) |
|---|---|---|
| 0 | 0 | — |
| 60 | 5 | 82 |
| 160 | 10 | 62 |
| 240 | 15 | 54 |
| 370 | 20 | 40 |
| 500 | 25 | 38 |
| 660 | 30 | 32 |
| 840 | 35 | 30 |
| 1020 | 40 | 27 |
| 1220 | 45 | 27 |
| 1630 | 55 | 25 |
| 1860 | 60 | 22 |
| 2090 | 65 | 20 |

*Average Flux between the last and the current measuring point

The unit was drained, and water was used as the media in a continuous filtration at 0.5 bar with the vibration motor at 15 Hz and partly opened retentate outlet for 15 min.

A 30 min. lye wash pH 11 with 1.25% Divos 120 CL at 50° C. was performed at 0.5 bar pressure and the vibration motor at 15 Hz was performed with partly opened retentate outlets. The unit was drained and flushed thoroughly with water.

The unit was drained and flushed. The average water flux was measured after 10 min. to 370 LMH over a 1 min period.

Conclusion: A 15 Hz vibration made the orange juice filtration faster and unit was seen to be performing as larger unit using same membrane.

1-15. (canceled)

16. A filtration device comprising:
a filter module adapted for filtration of media, the filter module comprising one or more flat vessel chambers, each of the flat vessel chambers is formed between two or more parts and comprises one or more flexible volume chambers positioned in each end of the flat vessel chamber;
at least one inlet for the media to be filtered;
at least one outlet for retentate, wherein the inlets and the outlets are positioned at distal ends of the vessel chamber; and
at least one semipermeable membrane forming a wall separating the vessel chamber from a drain area, the drain area comprising a permeate outlet.

17. The filtration device according to claim 16, wherein each of the two flexible volume chambers comprises a flexible gasket adapted to separate a gas volume of the flexible volume chambers from the vessel chamber, other walls of the flexible volume chambers being rigid.

18. The filtration device according to claim 16, wherein each of the two flexible volume chambers can be connected to a gas pressure source for increasing or decreasing volume of the flexible volume chambers.

19. The filtration device according to claim 16, wherein the two flexible volume chambers comprise a flexible gas enclosure positioned at opposing ends of the vessel chamber.

20. The filtration device according to claim 16, wherein the vessel chamber has an overall planar design with at least one planar side covered by a semipermeable membrane, the planar side of the vessel chamber being formed with an overlaying structure.

21. The filtration device according to claim 16, comprising two or more of the filter modules, the two or more filter modules being connected to one or more vibration motors.

22. The filtration device according to claim 21, wherein each of the one or more flexible volume chambers has a longitudinal axis, and wherein the direction of vibrating motion from the one or more vibration motors is perpendicular to the longitudinal axis of the flexible volume chambers.

23. The filtration device according to claim 21, wherein the one or more vibration motors provide a vibration-driven dead-end filtration operation, and wherein one part of the media is concentrated in the vessel chamber and discharged at the end of operation or intermittently.

24. The filtration device according to claim 21, wherein the one or more vibration motors provide a continuous or intermittent vibration-driven filtration operation, and wherein one part of the media is concentrated in the vessel chamber and the vibration action keeps the flux of the semipermeable membrane filter area from leveling off.

25. The filtration device according to claim 16, wherein continuous separating media enters the filtration device through the inlet, the media having (i) high solids content, (ii) high viscosity, (iii) high sanitary demand, or (iv) for concentrating or separating such as polypeptides, enzymes, proteins, yeast, or cells in a liquid and/or a combination thereof in a permeate phase exiting the device through the permeate outlet and a retentate phase exiting the device through outlet.

26. The filtration device comprising:
a filter module adapted for pressure and vibration driven filtration of media, the filter module comprises at least first and second half parts that are adapted for edgewise bonding, the first and second half parts together creating an internal flat vessel chamber,
wherein a first half part comprises in one end a feed inlet and in the opposite end a retentate outlet, the first half part further comprising at least two flexible volume chambers being filled with gas, being spaced apart within the first part, and being proximal to the feed inlet and the retentate outlet, respectively, and
wherein the second part comprises a permeate outlet, a drain area, and a semipermeable membrane covering the drain area and being fluid tight sealed between the drain area and the vessel chamber; and
a vibration motor having a receptacle for mounting the filter module, the vibration motor being adapted to provide a vibrating motion to the filter module, and
wherein the flexible volume chambers have at least one flexible chamber wall planar to the flat vessel chamber and adapted to expand and/or compress a volume of the flexible volume chambers to allow a retentate to be filtered in the vessel chamber to move back and forth relative to a surface of the semipermeable membrane in response to the filtration device being subjected to the vibrating motion.

27. The filtration device according to claim 26, wherein the vibration motor is adapted to provide the vibrating motion of a linear or circular nature or a combination of both.

28. The filtration device according to claim 26, wherein the vibration motor provides vibration motion to the filter module through an eccentric axis.

29. A filtration device comprising:
a filter module adapted for continuous pressure and vibration driven filtration of media, the filter module comprising at least a first part and a second part being adapted for edgewise bonding, the first and second parts creating an internal flat vessel chamber,
wherein the first part comprises a feed inlet in one end, a retentate outlet in an opposite end, and one or more flat planar semipermeable membrane between the feed inlet and the retentate outlet, the first part further including a drain area, the semipermeable membrane forming the side of vessel chamber wall and is positioned on top of the drain area, the drain area is positioned in a cavity in the first part and connected to the permeate drain, the semipermeable membrane is edgewise sealed and bonded to the first part,
wherein the second part includes flexible volume chambers at either end of the long flat vessel chamber, the flexible volume chambers are sealed off from the vessel chamber by a flexible gasket membrane that is generally parallel to the flat vessel chamber and is sealed to the second part,
a vibration driving motor connected to the filter module via the connection receptacle to cause the filter module to vibrate (i) back and forth or (ii) up and down when suspended in suitable springs.

30. The filtration device according to claim 29, wherein the vibration motor is adapted to provide the vibrating motion of a linear or circular nature or a combination of both.

31. The filtration device according to claim 29, wherein the vibration motor provides vibration motion to the filter module through an eccentric axis.

32. A filtration device comprising:
a filter module comprising two flat vessel chambers, each of the flat vessel chambers with one or more membrane areas, the filter module comprising two outer parts and one module part, and
wherein a retentate inlet, a retentate outlet, flexible cushions, a membrane, a drain area, and a permeate drain are positioned on the two outer parts, and
wherein the module part includes a membrane-covered drain on both sides and a permeate exit on the edge is positioned in between two outer parts, and
wherein the three module parts are edgewise bonded together to form the filter module, and
wherein the filter module is connected to the driving motor through the connection receptacle and the filter module can vibrate back and forth or up and down when suspended in suitable springs.
